(19) United States
(12) Patent Application Publication
(10) Pub. No.: US 2006/0176179 A1
(43) Pub. Date: Aug. 10, 2006

(54) Bendable, active radio-frequency sensor tags and a system of same

(75) Inventors: James R. Skorpik, Kennewick, WA (US); Brion J. Burghard, West Richland, WA (US); Gregory A. Speer, West Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/044,872

(22) Filed: Jan. 26, 2005

(51) Int. Cl. G08B 13/14; G08B 1/08

(52) U.S. Cl. 340/572.8; 340/539.1

(57) ABSTRACT

Bendable, active radio-frequency (RF) sensor tags and a system of comprising active RF sensor tags are disclosed in the specification. The active RF sensor tags can comprise an RF transceiver, a microprocessor, an antenna embedded in the sensor tag, a timing element, a memory device to store data, at least one bendable battery, a sensor, and a bendable housing enclosing the above components. The sensor can reside internal, or external to the active RF sensor tag.

An embodiment of the present invention encompasses a bendable, active radio-frequency (RF) tag (i.e., FlexiTag) having a plurality of power-consumption modes, which can include a power-saving sleep mode, a low-power RF sniff mode, and a fast RF sniff mode. The FlexiTag can comprise an application-specific, integrated-circuit (ASIC) RF chipset, an antenna, a timing element, at least one power source, and a bendable housing encasing the above components. While the ASIC RF chipset can comprise an RF transmitter, an RF receiver, and a microcontroller all in a single package, the FlexiTag can alternatively employ separate RF link and microcontroller chips. The antenna can operably connect to the RF chipset for sending and receiving wireless transmissions. The timing element can connect to the ASIC RF chipset and/or separate microcontrollers, if present. The timing element can be used as the RF and microcontroller clock(s). The power source can operably connect to the ASIC RF chipset and/or separate microcontrollers. In some embodiments, the bendable power source is connected to the circuitry described above through an activation device. The FlexiTag can further comprise at least one sensor for acquiring situational data regarding the environment surrounding the FlexiTag and/or at least one memory device to store data and operational firmware. The sensors can reside inside and/or outside of the bendable housing. In one embodiment, the FlexiTag is designed for single-use.

Another embodiment of the present invention encompasses a deployment of a plurality of FlexiTags in a given volume. The deployment of FlexiTags can also include at least one reader. The reader can comprise a FlexiTag, as previously described, additionally having an external-device communication interface, which allows the reader to communicate with higher-order devices, such as an interrogator.

It is an object of the present invention to provide low-cost, power-saving, FlexiTags. The tags are bendable to have the capability to conform to non-planar surfaces.

It is another object of the present invention to provide FlexiTags for long-term status monitoring of objects in harsh environments and/or difficult to reach locations.

It is yet another object of present invention to provide FlexiTags having a minimal number of rigid components to maximize the bendability of the tags. Thus, the tags can utilize bendable integrated circuits (ICs) and/or components having small footprints that do not impede the bending radius of the FlexiTags.

It is another object of the present invention to provide FlexiTags having low-power, RF-transmission capabilities and efficient power management.

### DESCRIPTION OF DRAWINGS

Embodiments of the invention are described below with reference to the following accompanying drawings.

FIG. 1 is a block diagram of one embodiment of a FlexiTag.

FIG. 2 is a drawing of the “paperclip” antenna at 916 MHz.

FIG. 3 is a block diagram of one embodiment of a FlexiTag comprising multiple sensors.

FIG. 4 is a perspective drawing of a FlexiTag encased in the bendable housing.

FIG. 5 is a block diagram of one embodiment of a FlexiTag having an activation device.

### DETAILED DESCRIPTION

For a clear and concise understanding of the specification and claims, including the scope given to such terms, the following definitions are provided.

As used herein, bendable does not only imply malleability, but can also refer to flexibility, resiliency, and the ability of an object to bend and/or flex without breaking or necessarily losing its original shape.

Single-use, as used herein, can refer to an object that is disposable and not designed for maintenance. For example, one embodiment of the present invention encompasses a low-cost FlexiTag that is completely encased in a bendable housing. In such an embodiment, no maintenance, such as battery replacement, is anticipated. Thus, the tag can be disposed of when depleted.

RF devices can be described by three classes—passive, semi-passive, and active. When used herein with reference to tags and RF communications, Active can refer to tags having RF communication electronics supplied by an on-board battery. Active tags are typically the most versatile and can be characterized by the presence of an active RF transmitter. In contrast, passive tags typically use backscatter modulation to reflect incoming RF energy to communicate via a code sequence. Passive tags do not usually contain batteries, but rather rely on the RF energy to power the electronic components. Semi-passive tags often have an energy-storage device (e.g., battery, capacitor, etc.) that powers the electronics. However, semi-passive tags use backscatter modulation for communication, like fully-passive tags.

A reader, as used herein, can refer to a device that interrogates RF tags within a given range. In one embodiment, the reader can be an RF tag-based device. Generally, the reader can have the ability to initiate transmission of command data and to retrieve information such as situational data, health, and more. The reader can comprise a FlexiTag, which has been designated and equipped to interrogate other tags. In such an instance, the FlexiTag/reader can have additional electronics and software to allow the reader to interface with a higher-order device including, but not limited to a PDA or laptop.

An interrogator can refer to a device that retrieves data from FlexiTags within range, typically through the reader. The interrogator can also have the ability to condition, display, process, or analyze the retrieved information. It can comprise a higher-order device, such as a computer, laptop, or PDA. Alternatively, it can comprise the combination of a higher-order device interfaced to the reader, as described above.

Situational data can refer to information regarding the physical conditions near or surrounding the FlexiTag, including, but not limited to temperature, acceleration, FlexiTag position, vibrations, shock, motion, strain, humidity, pressure, radiation, electrical fields, conductivity, impedance, magnetic fields, electromagnetic irradiation, chemical, biological, flow, viscosity, density, sound, ultrasound. It can also refer to an event, a series of events, object status, and more; for example, inappropriate tampering, human pulse rate, and battery life, respectively.

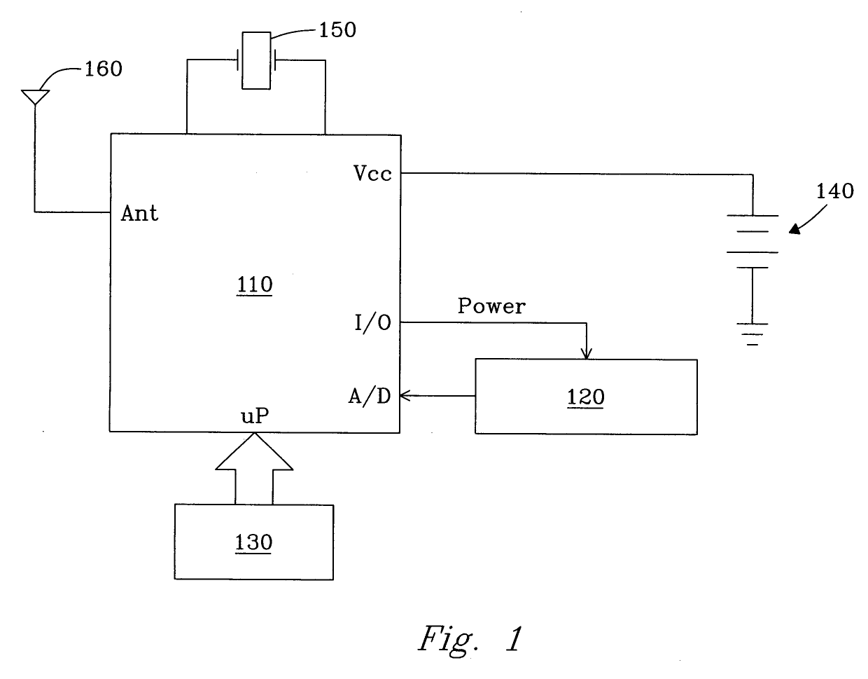

One embodiment of the present invention is an apparatus comprising a FlexiTag based on a low-power design that utilizes a minimum number of parts. Another embodiment utilizes flexible integrated circuits and components having minimal footprints so as not to compromise the tag's ability to bend. The apparatus can comprise an ASIC RF chipset, an antenna, a timing element, a memory device, at least one bendable power source, a bendable housing, and a sensor. Referring to the embodiment shown in FIG. 1, the antenna 160, timing element 150, memory device 130, and sensor 120 can operably connect to the RF chipset 110. Power for the electronics can be supplied by a bendable battery 140.

The ASIC RF chipset 110 can comprise, in a single package, an RF transmitter, RF receiver, and a microcontroller. Alternatively, a separate processor can be used instead of, or in addition to, the integrated microcontroller. The microcontroller (whether integrated with the RF link or not) can serve as the FlexiTag's system controller allowing the tag to perform application-specific requirements such as, but not limited to, sensor acquisition and data reporting. An embodiment of the present invention encompasses FlexiTags that do not use conventional memory devices, but rather utilize microchips having preprogrammed logic. For example, the memory-less FlexiTags can operate as finite state machines.

The RF transceiver can have multiple RF channels. The multiple channels can enable the FlexiTag to employ frequency hopping. The tag can operate at a number of frequency bands including, but not limited to industrial-scientific-medical (ISM) frequency bands. More specifically, the tag can operate at 2.4 GHz, 916 MHz, 868 MHz, or 433 MHz. Selection of a particular frequency band would involve outfitting the tag with the appropriately-tuned RF chipset and antenna.

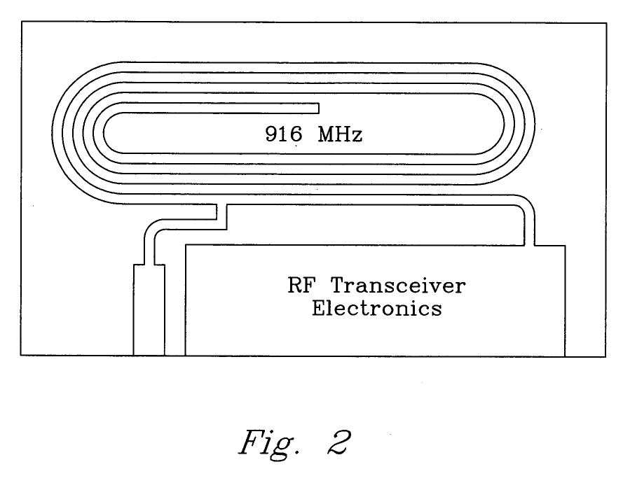

The antenna 160 can be external to the tag or it can be embedded within the housing and/or be part of the same printed circuit board as the FlexiTag. Furthermore, the FlexiTag can draw on a proximally-located object, or an object to which it is attached, for antenna functionality. The antenna can be tuned for transmission and/or reception of signals at a desired frequency and a variety of designs can be employed including, but not limited to, planar and loop. The antenna 160 can also employ a “paperclip” design. A paperclip antenna can comprise the proper width and length copper trace etched onto a printed circuit board and can look like a quarter wavelength antenna at the operational frequency. When available area on the circuit board is small, the copper trace can be folded into the shape of a paperclip. FIG. 2 shows a paperclip antenna designed to operate at 916 MHz. The actual length of the trace is frequency dependant, i.e., at higher operating frequencies the length of the antenna is much shorter then at lower frequencies. In one embodiment, at 2.4 GHz, the antenna can resemble a sideways letter ‘L’ and can occupy an area approximately 0.7×0.14 sq. in. In some embodiments, a plurality of antennae can be utilized to enhance diversity and/or allow for simultaneous transmission and reception at different frequencies.

The timing element 150, which can connect to the RF chipset 110 and/or the microcontroller, can regulate operation of the microcontroller. Alternatively, as will be described below, the timing element 150 can connect to both the memory device 130 and the RF chipset, or microprocessor, to allow autonomous initiation of a specific tag activity in response to particular events or stimuli. A common crystal oscillator can be a quartz crystal. A non-crystal example of a timing element includes timing circuits, which comprise logic modules that are self-timed. Thus, one embodiment of the present invention utilizes at least one clockless processor.

The memory device 130 can store information including, but not limited to, the tag's operational firmware, on-board software, routing indices, situational data, event history, background information regarding the object on which it is affixed, and combinations thereof. In one version of the invention, the memory device 130 can load the operational firmware into the RF chipset 110 upon tag power-up (boot loader). Multiple memory devices can be used in each FlexiTag for increased storage capabilities. Non-limiting examples of a memory device include random-access memory (RAM), read-only memory (ROM), programmable-read-only memory (PROM), electrically-erasable programmable read-only memory (EEPROM), flash memory, and combinations thereof. Some embodiments of the present invention do not require a memory device. Such tags can simply run a pre-programmed process in a repetitious fashion without storing any situational data.

Examples of bendable power supplies include, but are not limited to batteries, fuel cells, solar cells, thin films power sources, and combinations thereof. The FlexiTags can also draw power parasitically from nearby devices, or from objects to which it is attached. Examples of bendable batteries can include, but are not limited to, lithium-based or zinc-manganese-dioxide-based batteries. To maximize battery life, the batteries should have low leakage current that minimizes self discharging. One embodiment of the present invention encompasses a single-use FlexiTag. Therefore, the battery 140 can comprise non-toxic, non-flammable materials to minimize the environmental impact of battery disposal. Examples of such batteries include, but are not limited to POWERPAPER™ (Power Paper Ltd., Israel) and FLEXION™ (Solicore, Lakeland, Fla.).

Currently-available bendable batteries can be very thin (˜0.6 mm) and can be bent to a radius of curvature of approximately 25 mm. Next generation batteries, as well as other power sources, may exceed these specifications but fall within the scope of the present invention. Due to the fact that the flat, bendable batteries typically have relatively small volumes, they can have low amp-hour capacities (approximately 3V at 30 mA-hrs). While not critical to tag operation, the power sources should have straight, stable discharge curves until completely depleted. This enables the FlexiTags to exhibit steady performance over the lifetime of the tag. In order to achieve higher power densities, the FlexiTag can comprise a combination of the above-mentioned power sources, or a plurality of batteries, in either series or parallel configurations. When using multiple batteries, the batteries can be stacked to minimize the total surface area of the resultant tag.

The low amp-hour capacity can increase the need for efficient power management and dictate a low-power tag design. One embodiment of the present invention comprises a FlexiTag having a plurality of power-consumption modes, once activated. The modes include but are not limited to, a power-saving sleep mode, a low-power RF sniff mode, and a fast-sniff mode.

Since the greatest power-consuming activity can involve RF transmission and/or sniffing, the power-saving sleep mode can comprise a state characterized by a lack of RF activity. During the power-saving sleep mode, the FlexiTag can, for example, hibernate or it can collect situational data through its sensor. The tag can be programmed to switch out of the power-saving sleep mode in response to certain stimuli, including but not limited to time intervals, scheduled wake-ups, sensor events, and RF energy.

Situational data might also be collected during the low-power RF sniff mode. Additional activity can include, but is not limited to state-of-health checks and beacon transmissions. In this low-power mode, the FlexiTag can activate its receiver (i.e. sniffs) for a very short period at a regular interval or a predetermined time (i.e., time events). For example, the tag may sniff for approximately two milliseconds every several seconds or it might sniff at 3 am on even days and 5 pm on odd days. Regardless of receiver-activation schedule, the tag would consume as little power as necessary since the sniff period would be short. During the period in which the RF receiver would actually be activated, the tag would await an open-session command signaling the need to switch to the fast-sniff mode. The open-session command can indicate that data collection is forthcoming, for example, from the tag to the reader.

In the fast-sniff RF mode, the FlexiTag sniffs for commands at much shorter intervals than in the low-power RF sniff mode because additional commands will likely be received shortly. This mode can minimize the latency period required to respond to commands, which may have been sent by a reader or by another tag in the vicinity. A close-session command can return the tag to either the low-power RF sniff mode or the power-saving sleep mode. In the absence of a close-session command, the FlexiTag can autonomously revert to a low-power state following a pre-determined duration of no RF activity.

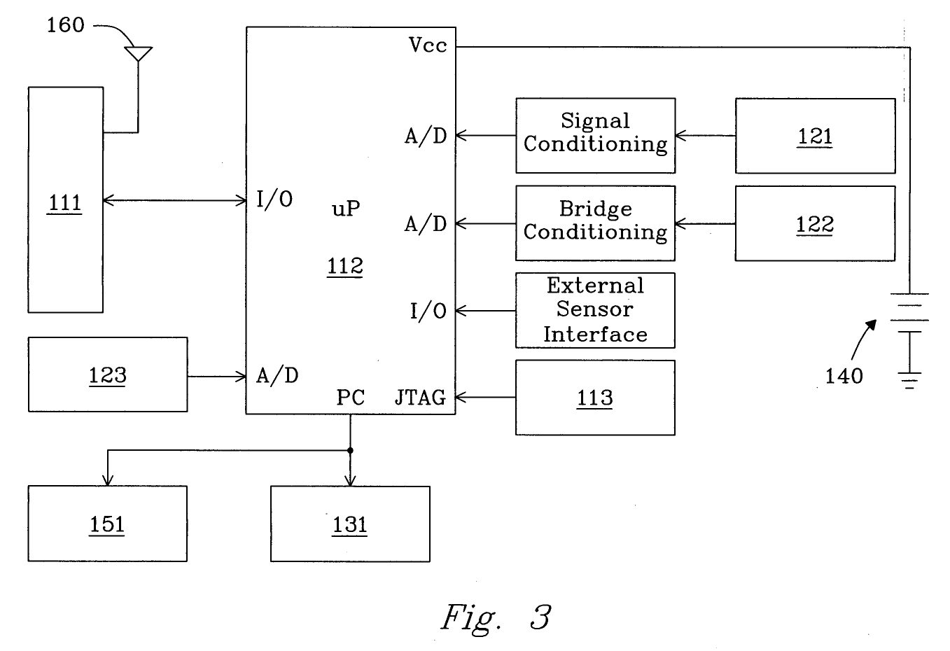

One way for the FlexiTag to autonomously initiate activity, which can include but is not limited to RF transmission/reception, data collection, and changes in power modes, is by operably connecting the timing element to the memory device and the microprocessor. In one embodiment, referring to FIG. 3, such a configuration can comprise connecting a real-time clock 151 to an EEPROM 131 and a microprocessor 112, which can be separate from the RF transceiver 111.

The embodiment in FIG. 3 further comprises a number of sensors and an external-device interfaces. The block diagram shows a three-axis accelerometer 121, a strain gauge 122, and a temperature sensor 123. Both the accelerometer and the strain gauge sensors can have conditioning electronics and require analog-to-digital conversion. In one embodiment, the conditioning electronics can be integrated in each sensor, which can be encased by the housing. Other internal sensors can acquire situational data including, but not limited to temperature, acceleration, vibrations, shock, motion, strain, humidity, pressure, radiation, and combinations thereof.

The FlexiTag of the present embodiment also has an interface for attaching a sensor that is external to the tag. This can allow collection of information including but not limited to humidity, pressure, radiation, chemical data, and biological data. Biological data can include, but is not limited to proteins, enzymes, antigens, antibodies, DNA sequences, human vital signs, and combinations thereof. The external-sensor device interface can comprise a physical connector adapting to standard interfaces including, but not limited to USB, parallel, serial, PCMCIA, BNC, fiber optic, BLUETOOTH, cell phone, IR, satellite link, land wire, internet link, acoustic coupling, and combinations thereof.

Another type of interface can be used to transfer data between a reader and an interrogator. Such an external-device interface can comprise the same types of physical connectors as listed for the external-sensor device interface. In one embodiment, the external-device interface can comprise a programming interface 113. The programming interface can be used, for example, to update firmware or perform initial FlexiTag setup.

In one embodiment, a designated FlexiTag can serve as a reader for a plurality of other FlexiTags within a given range. In such an instance, the reader can have additional functionality compared with the FlexiTags to be interrogated. For example, the reader can have the ability to initiate transmission of command data and to retrieve information including, but not limited to tag location, situational data, and tag health. Therefore, the reader can further comprise additional processing power, increased memory capacity, enhanced communication options, an external-device interface to communicate with the interrogator, and higher-capacity or additional batteries.

Additional processing power and increased memory capacity can be realized by utilizing superior, or additional, microprocessors and memory chips, respectively. The enhanced communication options can allow the reader to interface with a higher-order device such as a desktop computer, a laptop, a PDA, or some other device dedicated to communicating with the reader. Referring to FIG. 3, the programming interface 113 can provide for the enhanced communication options. Since the added functionality can require an increased part count, the reader can have a higher cost and larger size than the FlexiTag from which it derives, and can be designed for multiple use.

Elements described above including, but not limited to, the microcontroller, RF transceiver, ASIC RF chipset, the memory device, and the timing element can be mounted on a circuit board, which also interconnects the antenna and the battery to the other electronics. The circuit board can comprise a flexible electronic circuit board. Such boards can commonly comprise a polyimide-based substrate, such as KAPTON®, however any flexible board can conceivably be used. Alternatively, the ability to bend can be imparted by hingedly connecting a plurality of traditional, rigid circuit boards that are electrically connected. In one example, the hinges connecting the rigid circuit boards can comprise thin copper wires supported by, or formed in, a flexible substrate.

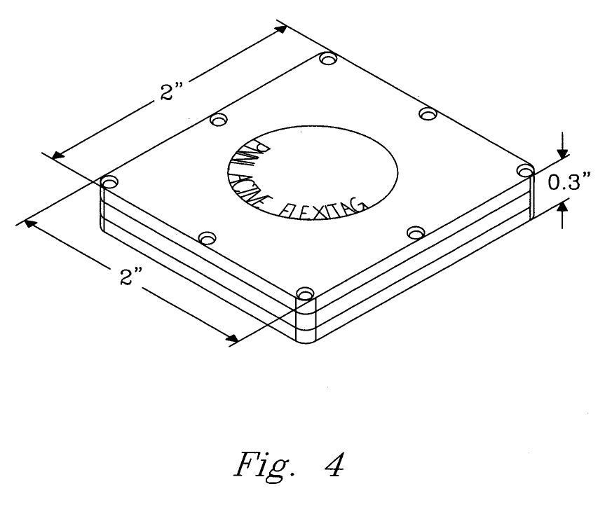

The housing of the FlexiTag can be selected for reliable operation under rugged conditions including but not limited to those existing in industry, manufacturing, emergency-response situations, battlefields, severe weather, harsh chemical environments, high-radiation areas, and difficult to access areas. While FIG. 4 shows an embodiment of the present invention, having dimensions of approximately 2×2×0.3 in³, FlexiTags as small as 1.8×1.4×0.25 in³ have been constructed. The dimensions described herein are exemplary in nature and are not intended to limit the scope of the present disclosure. The housing can comprise a bendable material including, but not limited to, sheet metal or polymers. One example of a polymer is an epoxy. To protect the electronics, the housing can completely encase the RF transceiver, microcontroller, antenna, timing element, memory device, and battery. In embodiments having internal sensors, the housing can further encase the sensor. For embodiments having an optically-based communication device, the housing can further comprise a light-transmissive window. Alternatively, the entire housing can comprise a light-transmissive material such as a clear polymer.

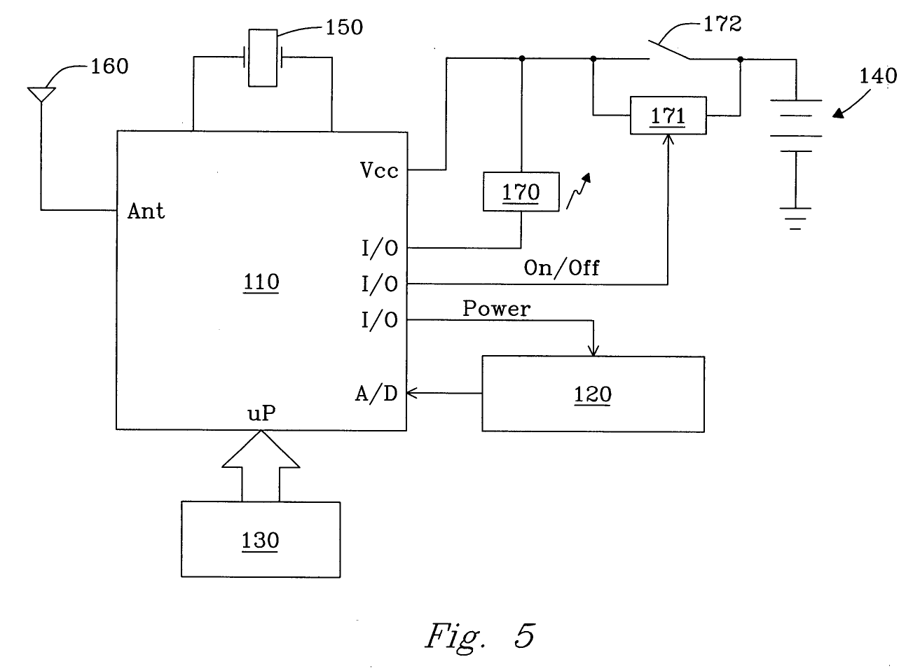

Since some versions of the present invention can be completely enclosed by the bendable housing, the FlexiTags can further comprise an activation device. Referring to the embodiment shown in FIG. 5, a mechanical reed switch 172 can remain open and prevent activation of the tag. The reed switch 172 can be sensitive to a magnetic field. Bringing a magnet within proximity of the switch location can cause the switch contacts to close, thereby connecting the bendable battery 140. A physical marking on the outside surface of the tag's housing can denote the switch's location. Upon power up, the microcontroller can activate a solid-state switch 171 in parallel with the reed switch, thus allowing the magnet to be removed. The solid-state switch can comprise a field-effect transistor (FET). The activation device can further comprise an onboard indicator to indicate that the power has been activated. The indicator can comprise a color-changing device, an optical device, an auditory device, or a combination thereof. In the present embodiment, the indicator comprises an LED 170.

Alternatively, the activation device can be optically-based, in which a photocell is employed as a receiver. A light beam can excite the photocell to produce a voltage output. The photocell output can activate a switch to connect the battery. The microcontroller can then toggle an output line that drives the same switch allowing the light source to be removed.

The FlexiTag of the present invention can be useful in a number of applications, wherein a plurality of tags can be deployed in a given volume. Among the plurality of FlexiTags can exist at least one reader. In one configuration, a relatively large number of tags can act as slave units to relatively few readers. Depending on the communication protocol, the reader can communicate with each FlexiTag directly, or communication can be established through intermediate tags. One example of a communication protocol is described in U.S. Patent Application Attorney Docket 14423-B B, entitled Method for Autonomous Establishment and Utilization of an Active-RF Tag Network, by Burghard et al., which description is incorporated herein by reference. In order to maximize the distance between FlexiTags, a plurality of signal-repeater tags can be co-deployed. The signal-repeater tags can comprise an RF transceiver, a microprocessor, and a battery and can serve to receive and re-transmit data between the reader and the FlexiTags and/or between FlexiTags. Alternatively, the FlexiTags themselves can serve as signal-repeater tags. An interrogator can then retrieve the data from the reader for analysis and/or taking appropriate actions. The following examples are provided to illustrate specific applications of the FlexiTags.

### EXAMPLE 1

### Equipment Health Monitor

The FlexiTags can be employed to monitor the health of a piece of equipment. Many devices can have a vibration and/or resonant frequency during normal operation. Examples of such equipment can include, but are not limited to windmills, pumps, pistons, motors, and other devices having regular motion. When the frequency begins to change or drift, it can indicate failure, wear, and/or a need for maintenance. A FlexiTag having an accelerometer can monitor the vibration frequency and provide early notice of required maintenance. Similarly, a FlexiTag having a temperature sensor can monitor a change in temperature, which may indicate an abnormal increase in friction between moving parts, overheating electronics, and more. Alternative health-monitoring techniques, which would also apply to equipment in which vibrations are damped or absent, can include, but are not limited to, measuring the humidity, impedance, and/or strain. For example, long periods of elevated humidity levels can suggest higher potential for corrosion. Similarly, an increase in impedance could indicate deterioration of electrical components caused, perhaps, by corrosion and/or oxidation. FlexiTags having strain gauges could be used to monitor deformation of structural components and members to accurately indicate the need for repair or replacement of such components. Strain gauges would also be applicable in monitoring long-term curing of objects to ensure that excess volume changes do not result in faulty products after curing.

Since the FlexiTag described herein can bend, it can be attached to non-planar surfaces of the equipment including, but not limited to, a drive shaft or cylindrically-shaped housing. The FlexiTag can have an adhesive backing to simplify attachment of the tag to the equipment.

Ultimately, the FlexiTags can be used to monitor the health of a variety of objects and equipment, which might need maintenance, by including the appropriate sensor in the tag. FlexiTags are especially applicable to those objects having non-planar surfaces, those that are difficult to reach, and those that might benefit from real-time monitoring.

### EXAMPLE 2

### Advanced Inventory Monitoring

The FlexiTags can be employed to monitor a particular inventory. In addition to tracking presence and location of the inventory, the FlexiTags of the present invention can monitor situational data in real-time and can record event history. This type of monitoring can be relevant to items requiring particular ambient conditions during storage and/or transportation. Such items can include but are not limited to, food products, weapons, live animals, chemicals, pharmaceuticals, and delicate specialty items. Furthermore, an accelerometer can measure sudden impacts that might indicate tampering or improper handling. FlexiTags can be attached to such items and can monitor temperature, pressure, humidity, vibration, electric fields, magnetic fields, etc. and can alert operators if unfavorable conditions develop. The active RF sensor tag can also comprise geolocation electronics for identifying the position of the tag. An example can include a global positioning system (GPS). The acquisition and data storage capabilities on the FlexiTag can allow the receiver of the items to review the historic conditions before accepting delivery to ensure that the items were handled properly.

### EXAMPLE 3

### Vital signs of Emergency Workers and Soldiers

The FlexiTags can be employed to monitor vital signs including, but not limited to, the heart rate, pulse, temperature, blood pressure, and brain waves of humans. The tags can be attached to a soldier or emergency worker's clothing, equipment or skin. In one configuration, a plurality FlexiTags can be attached to the individual along with at least one reader. The reader could periodically collect health data, which can then be transmitted to a feedback system and/or an interrogator that can respond by notifying the individual or sending an alert to others in the vicinity.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An apparatus comprising:
a. an RF transceiver operably connected to at least one microcontroller;
b. an antenna operably connected to said RF transceiver;
c. a timing element operably connected to regulate said microcontroller;
d. at least one power source operably connected to provide power to said RF transceiver and said microcontroller;
e. a bendable housing encasing said RF transceiver, said microcontroller, said antenna, and said timing element;
wherein said apparatus comprises a bendable, active RF tag having a plurality of power-consumption modes.

2. The apparatus as recited in claim 1, comprising a single-use, bendable, active RF sensor tag.

3. The apparatus as recited in claim 1, wherein said microcontroller performs application-specific functions comprising sensor acquisition and data reporting.

4. The apparatus as recited in claim 1, wherein said RF transceiver and said microcontroller are contained in a single package.

5. The apparatus as recited in claim 4, wherein said single package comprises an ASIC RF chipset.

6. The apparatus as recited in claim 1, wherein said RF transceiver comprises an RF transmitter and an RF receiver.

7. The apparatus as recited in claim 1, wherein said RF transceiver manages multiple RF channels.

8. The apparatus as recited in claim 7, employing frequency hopping.

9. The apparatus as recited in claim 1, operating at ISM frequency bands.

10. The apparatus as recited in claim 9, wherein said ISM frequency bands are selected from the group consisting of 2.4 GHz, 916 MHz, 868 MHz, and 433 MHz, and combinations thereof.

11. The apparatus as recited in claim 1, wherein said antenna is embedded within said apparatus.

12. The apparatus as recited in claim 1, wherein said antenna comprises a planar antenna.

13. The apparatus as recited in claim 1, wherein said antenna comprises a loop antenna.

14. The apparatus as recited in claim 1, wherein said antenna comprises a paperclip antenna.

15. The apparatus as recited in claim 1, further comprising a plurality of antennae.

16. The apparatus as recited in claim 1, wherein said antenna draws on a proximally-located object for antenna functionality.

17. The apparatus as recited in claim 1, wherein said timing element operably connects to said RF transceiver.

18. The apparatus as recited in claim 1, wherein said timing element comprises a crystal oscillator.

19. The apparatus as recited in claim 1, wherein said timing element comprises a timing circuit.

20. The apparatus as recited in claim 1, further comprising at least one memory device operably connected to said microcontroller to store data;

21. The apparatus as recited in claim 20, wherein said memory device comprises memory types selected from the group consisting of RAM, ROM, PROM, EPROM, EEPROM, flash, and combinations thereof.

22. The apparatus as recited in claim 1, wherein said data comprises operational firmware, wherein said operational firmware loads into said microcontroller.

23. The apparatus as recited in claim 1, wherein said data comprises situational data.

24. The apparatus as recited in claim 1, wherein said data comprises application specific software to control operation of said microcontroller.

25. The apparatus as recited in claim 1, wherein said power source comprises a bendable power source selected from the group consisting of batteries, fuel cells, thin films, solar cells, and combinations thereof.

26. The apparatus as recited in claim 25, wherein said power source is embedded in said apparatus.

27. The apparatus as recited in claim 1, wherein said power source comprises a parasitic source.

28. The apparatus as recited in claim 1, wherein a plurality of said power sources are configured in series.

29. The apparatus as recited in claim 1, wherein a plurality of said power sources are configured in parallel.

30. The apparatus as recited in claim 1, further comprising an activation device operably connected to said power source to remotely activate said apparatus.

31. The apparatus as recited in claim 30, wherein said activation device further comprises a photocell, said photocell activating a switch connected to said power source upon illumination.

32. The apparatus as recited in claim 30, wherein said activation device further comprises a mechanical reed switch connected to said power source, said mechanical reed switch having sensitivity to a magnetic field.

33. The apparatus as recited in claim 30, further comprising an onboard indicator signaling activation of said power source.

34. The apparatus as recited in claim 33, wherein said onboard indicator is selected from the group consisting of color-changing devices, optical devices, auditory devices, and combinations thereof.

35. The apparatus as recited in claim 34, wherein said optical devices comprise an LED.

36. The apparatus as recited in claim 1, further comprising a sensor for acquiring situational data, said sensor operably connecting to said microcontroller;

37. The apparatus as recited in claim 36, wherein said sensor resides inside or outside of said bendable housing

38. The apparatus as recited in claim 36, wherein said situational data comprises data selected from the group consisting of temperature, acceleration, vibrations, shock, motion, strain, humidity, pressure, radiation, electrical fields, conductivity, impedance, magnetic fields, electromagnetic irradiation, chemical, biological, flow, viscosity, density, sound, ultrasound, and combinations thereof.

39. The apparatus as recited in claim 38, wherein said sensor is embedded inside said apparatus when said situational data comprises data selected from the group consisting of temperature, acceleration, vibrations, shock, motion, strain, humidity, pressure, radiation, and combinations thereof.

40. The apparatus as recited in claim 36, wherein said sensor is external to said apparatus when said situational data comprises data selected from the group consisting of humidity, pressure, radiation, chemical, biological, and combinations thereof.

41. The apparatus as recited in claim 38, wherein said biological data comprises data selected from the group consisting of proteins, enzymes, antigens, antibodies, DNA sequences, human vital signs, and combinations thereof.

42. The apparatus as recited in claim 36, further comprising an external-sensor device interface.

43. The apparatus as recited in claim 42, wherein said external-sensor device interface comprises a connector adapting to interfaces selected from the group consisting of USB, parallel, serial, PCMCIA, BNC, fiber optic, BLUETOOTH, cell phone, IR, satellite link, land wire, internet link, acoustic coupling, and combinations thereof.

44. The apparatus as recited in claim 1, wherein an electronic circuit board connects elements comprising said RF transceiver, said microcontroller, said antenna, and said power source.

45. The apparatus as recited in claim 44, wherein said electronic circuit board comprises a bendable electronic circuit board.

46. The apparatus as recited in claim 45, wherein said bendable electronic circuit board comprises a polyimide-based substrate.

47. The apparatus as recited in claim 44, wherein said electronic circuit board comprises a plurality of rigid circuit boards hingedly connected and in operable electrical communication.

48. The apparatus as recited in claim 47, wherein a connection for said plurality of rigid circuit boards comprise conductive wires supported by flexible substrates.

49. The apparatus as recited in claim 1, wherein said bendable housing comprises a material selected from the group consisting of sheet metal, polymer, and combinations thereof.

50. The apparatus as recited in claim 49, wherein said polymer comprises epoxy.

51. The apparatus as recited in claim 1, wherein said apparatus is a reader.

52. The apparatus as recited in claim 51, wherein said reader further comprises an external-device communication interface to communicate with an interrogator.

53. The apparatus as recited in claim 52, wherein said external-device communication interface comprises a connector adapting to interfaces selected from the group consisting of USB, parallel, serial, PCMCIA, BNC, fiber optic, BLUETOOTH, cell phone, IR, satellite link, land wire, internet link, acoustic coupling, and combinations thereof.

54. The apparatus as recited in claim 52, wherein said external-device communication interface is a programming interface.

55. The apparatus as recited in claim 1, wherein said plurality of power-consumption modes comprise a power-saving sleep mode, a low-power RF sniff mode and a fast RF sniff mode.

56. The apparatus as recited in claim 55, wherein a stimulus can cause said apparatus to change between said plurality of power-consumption modes.

57. The apparatus as recited in claim 56, wherein said stimulus comprises events selected from the group consisting of time events, sensor events, wireless commands, RF energy, and combinations thereof.

58. The apparatus as recited in claim 1, wherein said sensor further comprises geolocation electronics to identify a position of said active RF sensor tag.

59. The apparatus as recited in claim 58, wherein said geolocation electronics comprises a global positioning system.

60. An apparatus comprising a bendable, single-use, active RF tag comprising a plurality of power-consumption modes and a bendable housing encasing said apparatus.

61. The apparatus as recited in claim 60, further comprising at least one sensor for acquiring situational data

62. The apparatus as recited in claim 60, wherein said apparatus further comprises an external-sensor device interface to receive situational data from an external sensor.

63. The apparatus as recited in claim 60, wherein said bendable, single-use, active RF tag further comprises:
a. RF communication electronics to transfer data to a reader, said data comprising situational data and command data;
b. sensor electronics to acquire and condition said situational data;
c. a microcontroller to process said data and to provide operational control of said apparatus, said microcontroller utilizing at least one memory device to store data and a timing element to regulate operation of said microcontroller and said RF communication electronics;
d. at least one bendable battery to provide power to said RF communication electronics, said sensor electronics, and said microcontroller; and
wherein said RF communication electronics, said sensor electronics, and said microcontroller are operably mounted on a bendable circuit board for electrical communication.

64. The apparatus as recited in claim 63, wherein said RF communication electronics and said microcontroller are packaged in a single chip.

65. The apparatus as recited in claim 64, wherein said single chip comprises an ASIC RF chipset.

66. The apparatus as recited in claim 63, further comprising additional microcontrollers to provide increased processing capabilities.

67. The apparatus as recited in claim 63, further comprising an antenna formed in said bendable circuit board.

68. The apparatus as recited in claim 63, wherein said bendable circuit board comprises a polyimide-based substrate.

69. The apparatus as recited in claim 63, wherein said bendable circuit board comprises a plurality of rigid circuit boards hingedly connected and in operable electrical communication.

70. The apparatus as recited in claim 63, wherein said bendable housing comprises a material selected from the group consisting of sheet metal, polymer, and combinations thereof.

71. The apparatus as recited in claim 70, wherein said polymer comprises epoxy.

72. A system comprising:
a. a plurality of bendable, active RF tags each comprising a plurality of power-consumption modes; and
b. at least one reader;
said system comprising a deployment of bendable, active RF tags for wireless communication with said reader.

73. The system as recited in claim 72, wherein said bendable, active RF tag further comprises at least one sensor for acquiring situational data.

74. The system as recited in claim 72, wherein said plurality of power-consumption modes comprises a power-saving sleep mode, a low-power RF sniff mode and a fast RF sniff mode.

75. The system as recited in claim 72, further comprising RF-signal repeater tags.

76. The system as recited in claim 72, wherein said bendable, active RF tags are single-use tags.

77. The system as recited in claim 72. wherein said bendable, active RF tags further comprise:
a. RF communication electronics to transfer data to an reader, said data comprising situational data and command data;
b. sensor electronics to acquire and condition said situational data;
c. a microcontroller to process said data and to provide operational control of said apparatus, said microcontroller utilizing at least one memory device to store data and a timing element to regulate operation of said microcontroller and said RF communication electronics;
d. at least one power source to provide power to said RF communication electronics, said sensor electronics, and said microcontroller; and
e. a bendable housing encasing said RF communication electronics, said sensor electronics, and said microcontroller;
wherein said RF communication electronics, said sensor electronics, and said microcontroller are operably mounted for electrical communication on a bendable circuit board.

78. The system as recited in claim 72, comprising equipment health monitors.

79. The system as recited in claim 72, comprising advanced inventory monitors.

80. The system as recited in claim 72, comprising vital-sign sensors for humans.
